(19) United States
(12) Patent Application Publication
(10) Pub. No.: US 2012/0013803 A1
(43) Pub. Date: Jan. 19, 2012

(54) Method circuit and system for receiving a signal

(76) Inventor: Roy Oren, Magshimim (IL)

(21) Appl. No.: 13/067,591

(22) Filed: Jun. 13, 2011

(30) Foreign Application Priority Data
Jul. 13, 2010 (CN) 201010229785.1

(51) Int. Cl. H04N 3/27; H04B 1/06

(52) U.S. Cl. 348/554; 455/272; 348/E03.049

(57) ABSTRACT

A method, circuit and system for receiving a data signal uses two or more antennas adapted to receive a common data signal. The system includes mode selection logic to determine a mode of extracting data from a common signal received on either or both antennas. The mode may include a signal combination mode and/or a noise reduction mode.

### CROSS-REFERENCE TO RELATED APPLICATIONS

The present application claims the benefit of Chinese Application 201010229785.1 filed on Jul. 13, 2010, the disclosure of which is incorporated herein by reference.

### FIELD OF THE INVENTION

The present invention relates generally to the field of communication. More specifically, the present invention relates to a method, circuit and system for receiving a signal through one or more antennas.

### BACKGROUND

Modern communication networks are characterized by features such as high bandwidth/data-rate, complex communication protocols, various transmissions medium, and various access means. Fiber optic networks span much of the world's surface, acting as long-haul networks for carrying tremendous amounts of data between distant points on the globe. Cable and other wire-based networks supplement coverage provided by fiber optic networks, where fiber networks have not yet been installed, and are still used as part of local area networks (“LAN”), for carrying data between points relatively close to one another. In addition to wire-based networks, wireless networks such as cellular networks (e.g. 2G, 3G, CDMA, WCDMA, WiFi, etc.) are used to supplement coverage for various devices (e.g. cell phone, wireless IP phone, wireless internet appliance, etc.) not physically connected to a fixed network connection. Wireless networks may act as complete local loop networks and may provide a complete wireless solution, where a communication device in an area may transmit and receive data from another device entirely across the wireless network.

With the proliferation of communication networks and the world's growing reliance upon them, proper performance is crucial. High data rates and stable communication parameters at low power consumption levels are highly desirable for mobile communication devices. However, degradation of signal-to-noise ratio (“SNR”) as well as Bit energy to noise ratio (“Eb/No”) and interference ratios such as Carrier to-Interference (“C/I”) ratio occur to a signal carried along a transmission medium (e.g. coax, unshielded conductor, wave guide, open air or even optical fiber or RF over fiber). This degradation and interferences may occur in TDMA, CSMA, CDMA, EVDO, WCDMA and WiFi networks respectively. Signal attenuation and its resulting SNR degradation may limit bandwidth over a transmission medium, especially when the medium is air or open space.

Radio Frequency (“RF”) based wireless communication systems ranging from cellular communication systems to satellite radio broadcasting systems are highly prevalent, and their use is consistently growing. Due to the unshielded nature of the transmission medium of wireless RF based communication systems, they are particularly prone to various phenomenon, including interference signals or noise and fading signals, which tend to limit performance of such systems.

Thus, strong and stable signals are needed for the proper operation of a wireless communication device. In order to improve the power level of signals being transmitted over relatively long distances, and accordingly to augment the transmission distance and/or data rate, devices may utilize power amplifiers to boost transmission signal strength. In addition to the use of power amplifiers for the transmission of communication signals, receivers may use low noise amplifiers and variable gain amplifiers (“VGA's”) in order to boost and adjust the strength and/or amplitude of a received signal.

An additional problem with wireless RF based transmissions is that they may be characterized by a multipath channel between the transmitter antenna and the receiver antenna which introduces “fading” in the received signal power. The combination of attenuation, noise interference and “fading” is a substantial limitation for wireless data network and satellite operators, mitigating their ability to provide high data-rate services such as Internet access, video phone services and mobile digital video services.

There exists a need in the field of wireless communications for enhanced methods, circuits, devices and system for enhancing communication signal reception by a wireless receiver.

### SUMMARY OF THE INVENTION

The present invention is a method circuit and system for receiving a signal. According to some embodiments of the present invention, there is provided an RF receiver unit with two or more antennas spatially separated from one another. According to some embodiments of the present invention, the antennas may be utilized according to one of two or more modes of reception, for example: (1) signal combination, and (2) noise/signal subtraction. Mode selection logic, either integral or otherwise functionally associated with the receiver unit, may determine which mode of reception to implement using the two or more antennas. According to some embodiments of the present invention, a signal strength and/or signal quality measuring circuit may provide to the mode selection logic an indicator of received signal strength and/or signal quality at either or both of the antennas. In situations where the indicator indicates received signal strength and/or signal quality is above a given threshold value, a mode selection logic may cause the receiver unit to utilize the antennas in noise cancellation mode. In situations where the indicator indicates received signal strength and/or signal quality is below a given threshold value, the mode selection logic may cause the receiver unit to utilize the antennas in signal combination mode.

According to some embodiments of the present invention, the receiver unit may include a separate receiver (Rx) chain for each antenna, such that each Rx chain may include an amplifier, a down converter, filters and other receiver circuitry. A noise subtraction circuit may subtract from a communication signal received on a first Rx chain a noise signal received on a second Rx chain. Any method, technique or circuit for dual reception noise subtraction known today or to be devised in the future may be applicable to some embodiments of the present invention.

According to some embodiments of the present invention, one or more signal combination circuits may also be connected to the antennas, either directly or at some point at each of the antenna's respective Rx chains. The signal combination circuit may be part of or coupled to one or more baseband processors functionally associated with each of the Rx chains.

The mode selection logic may be adapted to substantially simultaneously: (1) activate the signal combination circuit, and (2) deactivate the noise subtraction circuit when the indicator indicates that both antenna's receive the signal with adequate quality and combination of the signal from the two antenna's will yield improved reception. Alternatively, the mode selection logic may be adapted to substantially simultaneously: (1) deactivate the signal combination circuit, and (2) activate the noise subtraction circuit when the indicator indicates a strong or good quality signal accompanied by some noise at one antenna, and mostly noise at the other antenna, such that activating the noise subtraction unit will yield better reception than if signal combination was used. According to some embodiments, the mode selection logic may also be adapted to determine which antenna's noise signal is to be subtracted from which antenna's communication signal, depending on which antenna is receiving a stronger/better communication signal.

According to some embodiments, the signal combination circuits and/or noise subtraction circuits may be part of a (multimode) data extractor. A receiver unit according to some embodiments may include a first receive chain including a first antenna and a second receive chain including a second antenna, each of which chains may be adapted to receive a common communication signal including common communication data. The receiver may include a multimode data extractor adapted to extract the common communication data from the communication signals received on either or both of said chains. Mode selection logic may be adapted to select a mode of operation from a set of selectable modes and to configure the multimode extractor based on the selected mode. The set of selectable modes may include (a) signal combination of the common signal received on both chains, and (b) noise subtraction of noise received on the first chain from a noisy signal received on the second chain.

A receiver according to some embodiments may include received signal parameter measurement circuitry adapted to measure at least one parameter of a signal received by each of the first and second chains, wherein the measured signal parameter may be signal strength and/or signal quality. The mode selection logic may select a mode of operation based on an output of the signal parameter measurement circuitry.

According to some embodiments, the set of selectable modes may include a chain selection mode, such that communication data is extracted from a signal received on only one of said chains. Chain selection mode may include at least a partial shutdown of an unselected chain. The set of selectable modes may also include a switching mode, such that the communication data is extracted from a signal received on only one of chains.

According to some embodiments, the receiver may be a mobile digital video receiver and the communication data may be digital video data.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 shows a functional block diagram of a receiver according to the prior art;

FIG. 2 signal diagrams showing a communication signal, noise and the combined communication signal received with the noise;

FIG. 3 is a functional block diagram showing a multi-antenna based receiver according to some embodiments of the present invention, including a multimode signal extractor and mode selection logic;

FIG. 4A is a functional block diagram of a signal extractor according to some embodiments of the present invention, wherein the multimode baseband processing processor includes both signal combining and noise subtraction circuits;

FIG. 4B is a functional block diagram of a signal extractor segment of FIG. 4A configured to operate in a signal combining mode and explicitly showing an exemplary signal combining circuit according to some embodiments of the present invention; and

FIG. 4C is a functional block diagram of a signal extractor segment of FIG. 4A configured to operate in a noise subtraction/reduction mode and showing an exemplary noise subtraction/reduction circuit according to some embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Unless specifically stated otherwise, as apparent from the following discussions, it is appreciated that throughout the specification discussions utilizing terms such as “processing”, “computing”, “calculating”, “determining”, or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Embodiments of the present invention may include apparatuses for performing the operations herein. This apparatus may be specially constructed for the desired purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs) electrically programmable read-only memories (EPROMs), electrically erasable and programmable read only memories (EEPROMs), magnetic or optical cards, or any other type of media suitable for storing electronic instructions, and capable of being coupled to a computer system bus.

The processes and displays presented herein are not inherently related to any particular computer or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the inventions as described herein.

According to some embodiments, there is provided an RF receiver which may use a combination of various techniques and circuits implementing these techniques to compensate for phenomenon resulting from weak signal and interference. For example, the RF receiver may form part of a mobile digital video receiver and the communication data may be digital video data.

Adaptive interference (or noise) cancellers may be in the receiver. An adaptive noise canceller may adaptively filter a noise reference input to maximally match and subtract out noise or interference from a primary (signal plus noise) input. A receiver according to embodiments of the present invention may use two antennae, one for receiving and sampling the noise (aggressor), and one to receive the signal which is accompanied by some amount of noise.

A receiver unit according to embodiments of the present invention may include a first receive chain including a first antenna and a second receive chain including a second antenna, wherein each of which the chains may be adapted to receive a common communication signal including common communication data. The receiver may include a multimode data extractor adapted to extract the common communication data from the communication signals received on either or both of said chains. Mode selection logic functionally associated with the receiver may be adapted to select a mode of operation from a set of selectable modes and to configure the multimode extractor based on the selected mode. According to further embodiments, the set of selectable modes may include: (a) a first mode including signal combination of the common signal received on both chains, and (b) a second mode including noise subtraction of noise received on the first chain from a noisy signal received on the second chain. According to yet further embodiments, the receiver may include received signal parameter measurement circuitry adapted to measure at least one parameter of a signal received by each of the first and second chains. The measured signal parameter may include signal strength and/or signal quality.

The set of selectable modes may further include chain selection mode, such that communication data is extracted from a signal received on only one of said chains. Chain selection mode may optionally include at least a partial shutdown of an unselected chain. The set of selectable modes may also include a switching mode, such that the communication data is extracted from a signal received on only one of the chains.

The mode selection logic may be adapted to select a mode of operation based on an output of said measurement circuitry.

According to embodiments, antenna diversity may use two or more antennas to improve the quality and reliability of a wireless RF link. Several antennas associated with a receiver which receives a transmission signal through different propagation paths may be associated with a signal extractor which uses the variations in the propagation paths in order to better reconstruct and/or estimate the originally transmitted signal.

Any one of the following techniques for receiver antenna diversity may be used as part of the present invention:

Switching—the signal from only one antenna is fed to the receiver for as long as the quality of that signal remains above some prescribed threshold. If and when this signal degrades, another antenna is switched in. Switching is the easiest and least power consuming of the antenna diversity schemes, as it requires only a single receiver, but does not yield a significant improvement in reception.

Selecting—as with switching, selection processing presents only one antenna's signal to the receiver at any given time. The antenna chosen, however, is based on the best signal-to-noise ratio (SNR) among the received signals. This requires that a pre-measurement takes place and that all antennas have established connections (at least during the SNR measurement), leading to a higher power requirement. The actual selection process can take place in between received packets or frames of information. This ensures that a single antenna connection is maintained as much as possible. Switching can then take place on a symbol-by-symbol basis if necessary, with typical switching time periods of several milliseconds.

Combining—In this scheme, all of the antennas continuously provide signals to the receiver, at all times. The signals are then “combined” and, depending on the sophistication of the system, can either be added directly (equal-gain combination—EGC) or weighted and added coherently (maximal ratio combination—MRC). Such a system provides the greatest resistance to fading, and thus the best performance, but since all the receive paths must remain energized; it also consumes the most power as it requires all the receiving paths to be active all of the time.

Signal noise and/or echo cancellation—may be used to subtract or mitigate the noise received on a first a first diversity receive path from the noise received with the signal on a second receive path.

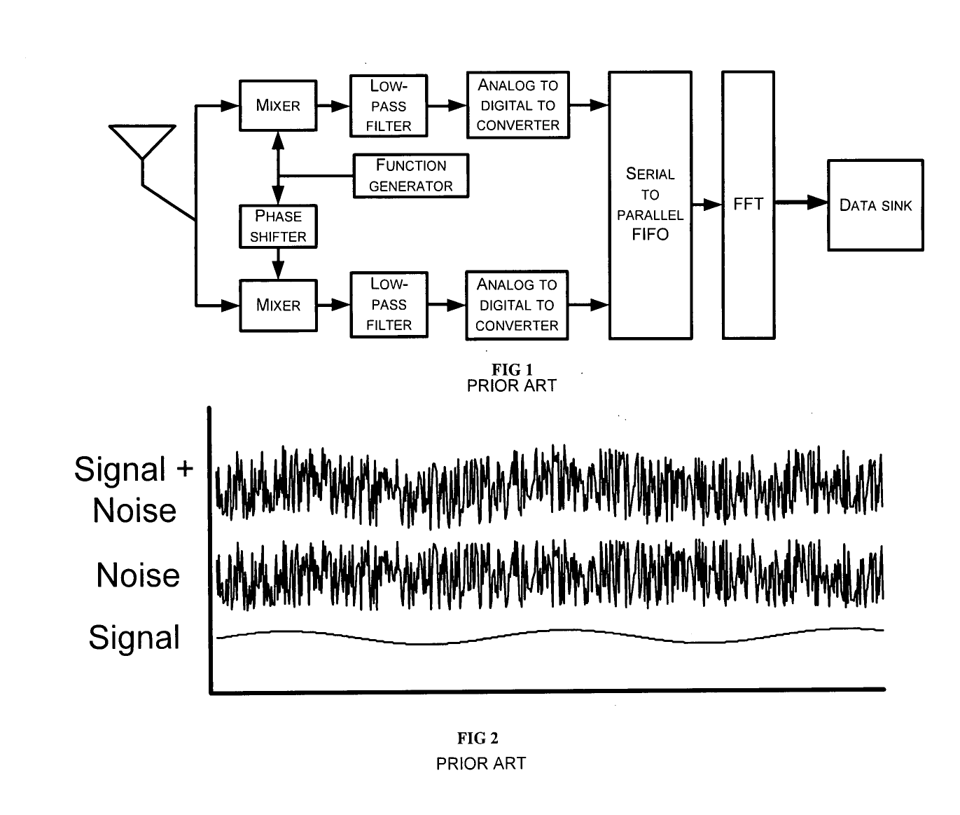

The present invention is a diversity reception based system, circuit and method for extracting a data baring signal from a received primary input, wherein the primary input may include the desired data signal along with noise. FIG. 1 shows an exemplary Orthogonal Frequency Multiple Access (“OFDM”) receiver with which the present invention may be implemented. FIG. 2 shows a set of signal diagrams with an exemplary data signal, an exemplary noise signal, and the combination of the signal+noise at a primary input to a receiver such as the one shown in FIG. 1. It should, however, be understood that the present invention may be implemented with any receiver architecture presently known or to be devised in the future.

According to various embodiments of the present invention, there may be provided a multimode signal extractor circuit adapted to switch between two or more methods, modes or techniques for extracting a data signal from a signal received at one or more antennas of the primary input having two or more antennas. There may be provided two or more antennas adapted to receive two or more (transmission) signals through two or more different propagation paths. According to some embodiments of the present invention, there may be provided a multimode signal extraction circuit or module for extracting the signal from the primary input. The signal may be extracted according to one of the embodiments listed below or according to any other technique known today or to be devised in the future.

According to some embodiments of the present invention, the signal may be extracted by using antenna one or more diversity switching techniques in which the signal from only one antenna may be fed to the receiver for as long as the quality of that signal remains above some threshold. If and when this signal degrades, another antenna may be switched in. According to some other embodiments of the present invention the signal may be extracted by using one or more antenna diversity selection techniques in which the signal from only one antenna which has the highest Signal-to-Noise-Ratio (SNR) at any given time may be fed to the receiver. According to some other embodiments of the present invention the signal may be extracted by using antenna diversity combining technique in which all of the antennas may continuously provide signal to the receiver, optionally at all times. The signals may then be “combined” and can either be added directly (equal-gain combination—EGC) or weighted and added coherently (maximal ratio combination—MRC). According to some other embodiments of the present invention, the data in the signal may be extracted by using a combination of antenna diversity combining and switching technique in which the signal from a fixed number (at least two) of antennas may be fed to the receiver for as long as the quality of the signals of the two or more antennas remains above some threshold. If and when the signal of two or more active antennas (the antennas connected to the receiver) degrades below a predetermined threshold, the one or more antennas with degraded signals may be switched out and another one or more antenna may be switched in, in a way that the number of antennas connected to the receiver remains fixed or may vary. Alternatively, the signal from at least one antenna may be fed to the receiver. Any signal which is above a (e.g. predetermined) threshold may be switched in and connected to the receiver, and any signal that falls below a threshold may be switched out and disconnected from the receiver. The threshold for switching in and the threshold for switching out may be the same or may be different. The signals connected to the receiver may then be “combined” and can either be added directly (e.g. equal-gain combination—EGC) or weighted and added coherently (e.g. maximal ratio combination—MRC). According to some other embodiments of the present invention, the data in the signal may be extracted by using a combination of antenna diversity combining and selection techniques in which the signal from a fixed number (i.e. at least two) antennas, which have the highest Signal-to-Noise-Ratio (SNR) at any given time may be fed to the receiver. Alternatively, the signals from any antenna that has a signal to noise ratio which is over some threshold at any given time may be fed to the receiver. The signals may then be “combined”, either by adding the signals directly (e.g. equal-gain combination—EGC) or by performing weighted adding coherently (e.g. maximal ratio combination—MRC).

According to some other embodiments of the present invention, the signal data may be extracted by using an adaptive noise canceller circuit and technique which: (1) uses a first of at least two antennas to receive a data bearing signal (which received signal is accompanied by some amount of noise), (2) uses a second of the at least two antenna to receive and sample the noise (aggressor), and (3) adaptively filters a noise reference input from the second antenna to maximally match and subtract out noise or interference from the primary (signal plus noise) input received on the first antenna.

According to some embodiments of the present invention, there may be at least one signal measuring module. The at least one signal measuring module may measure signal parameters such as signal strength, signal quality, signal-to-noise ratio (“SNR”), Bit energy to noise ratio (“Eb/No”) and interference ratios such as Carrier to-Interference (“C/I”) ratio. According to some embodiments of the present invention, each of a set of signal measuring modules may measure signal parameters of a single receiver on single receiver channel. According to some other embodiments of the present invention, a single signal measuring module may be multiplexed between several receiver channels and may measure signal parameters of several receiver channels.

According to some embodiments of the present invention, there may be provided a mode selection logic, circuit or module for selecting in which mode of operation an associated multimode extractor should operate. The mode selection module may receive measured signal parameters from the one or more signal measuring module(s) and may select a data signal extraction technique by applying a set of selection criteria or rules to the measured parameters. Optionally, the selection module may receive from other portions of the receiver reception requirements or criteria such as minimum power or maximum quality or any other operational criteria. The mode selection module may send a signal indicative of the selection result to the signal extraction module, and the extraction module may switch to the selected mode.

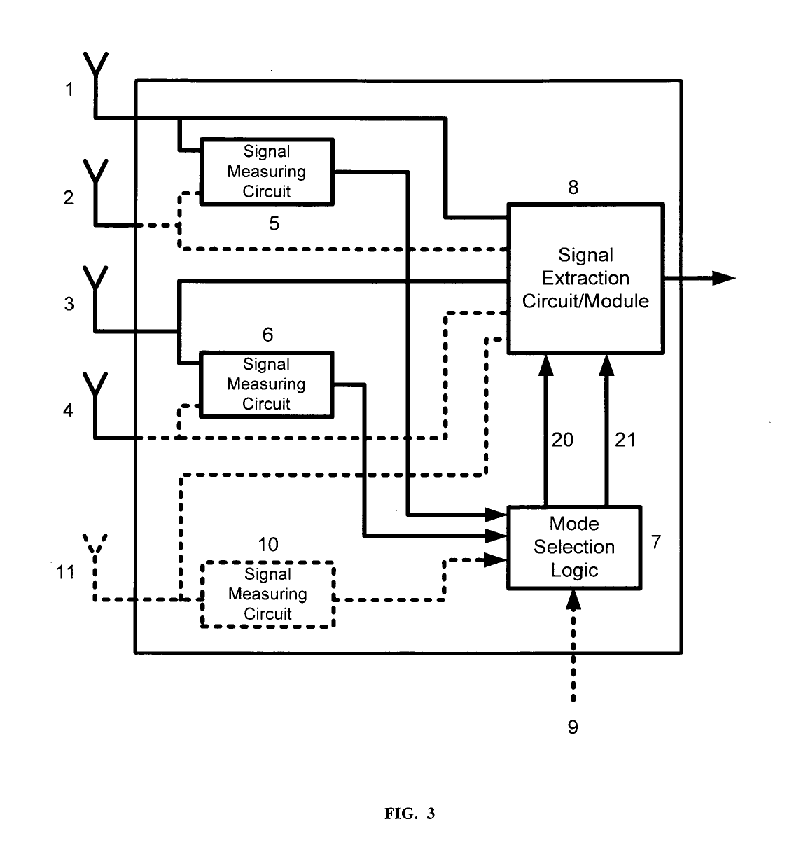

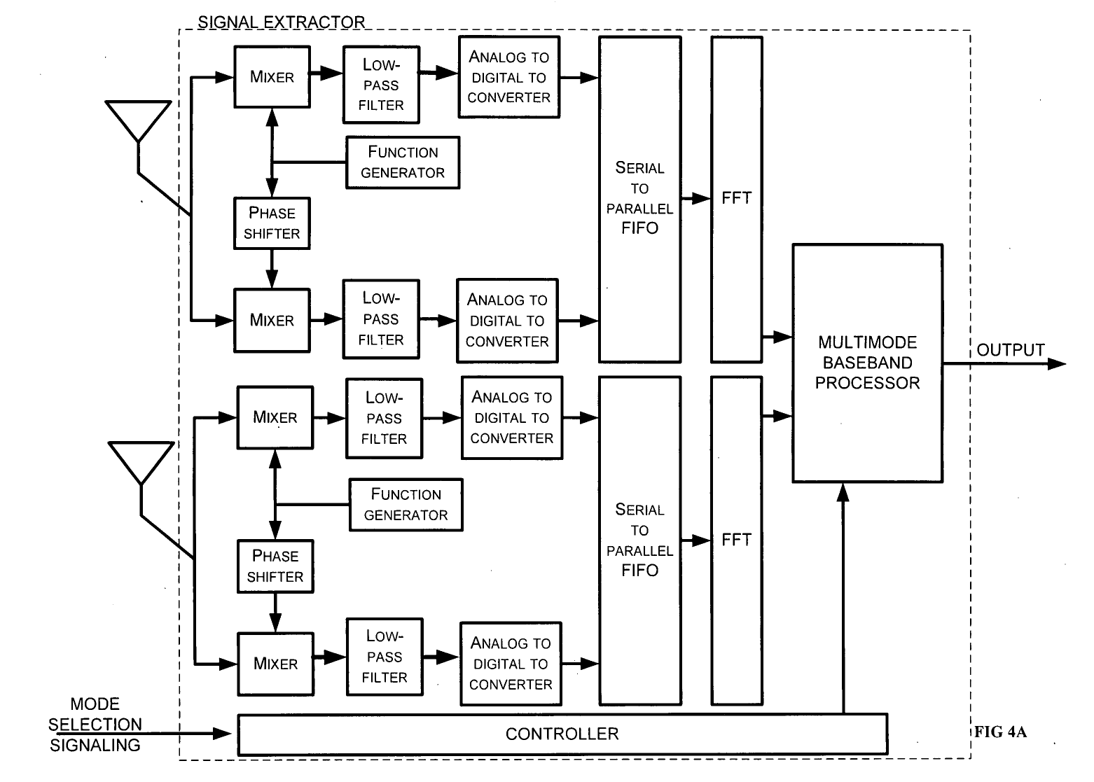

Turning now to FIG. 3, there is shown a functional block diagram of a multi-antenna based receiver according to some embodiments of the present invention, including a multimode signal extractor and mode selection logic. Signal extraction module 8 may receive primary input signals from antennas 1, 2, 3 and 4 and extract the signal according to one of the techniques mentioned above or according to any other technique known today or to be devised in the future. The extraction technique to be used may be selected by the mode selection module 7. Mode selection module 7 may receive signal parameters regarding the primary input signals from signal measuring modules 5 and 6, and may optionally receive information regarding selection criteria from an external input 9, the selected signal extraction technique to be used is sent to the signal extraction module through communication line 20. Signal measuring module 5 receives primary input signals 1 and 2 and may measure signal parameters for each primary input signal. Similarly, signal measuring module 6 receives primary input signals 3 and 4 and may measure signal parameters for each primary input signal. FIG. 3 concurrently illustrates several different optional embodiments of the present invention. In one embodiment, there may be only one signal measuring module 5 receiving all the primary input signals from at least antennas 1 and 2. In another embodiment, there may be at least two signal measuring modules 5 and 6, each receiving only one primary input signal, signal measuring modules 5 receives primary input signal 1 and signal measuring modules 6 receives primary input signal 3. If there are more than two antennas, the additional primary input signals from the additional antennas (antenna 11 or more) may be measured by an additional signal measuring modules (signal measuring module 10 or more). In another embodiment, there may be at least two signal measuring modules 5 and 6, each receiving at least one primary input signal, signal measuring modules 5 receives primary input signal 1 and optionally primary input signal 2, and signal measuring modules 6 receives primary input signal 3 and optionally primary input signal 4. If there are more antennas, the additional primary input signals from the additional antennas may be measured by signal measuring modules 5 or 6 or by additional signal measuring modules (signal measuring module 10 or more).

According to some embodiments of the present invention, the mode selection module may receive signal parameters regarding the primary input signals from the at least one signal measuring module(s). The signal parameters may include signal strength, signal quality, signal-to-noise ratio (“SNR”), Bit energy to noise ratio (“Eb/No”) and interference ratios such as Carrier to-Interference (“C/I”) ratio, or any other relevant signal parameter. According to some embodiments of the present invention, the mode selection module may also receive information regarding selection criteria such as minimum power or maximum quality or any tradeoff between the two, thresholds for transitions between signal extraction techniques, or any other desired selection criteria. The mode selection module may continuously or intermittently, calculate and determine the signal extraction technique to be used according to the signals' parameters and the selection criteria. For example, when a first primary input receives a signal with a very low signal to noise ratio (SNR) and a second primary input receives a signal with a high signal to noise ratio, the mode of adaptive noise canceller technique may be selected. In this mode the second antenna may be used to receive the signal, which is accompanied by some amount of noise and the first antenna may be used to sample the noise and adaptively filters a noise reference input to maximally match and subtract out noise or interference from the primary (signal plus noise) second input. If the signal to noise ratio of the first primary input increases, the performance of the adaptive noise canceller technique will degrade dramatically since the first primary input will include a higher level of the signal which will be subtracted from the second primary input. In this case the mode selection module may prefer to select the antenna diversity combining technique so that the signals from the first primary input and the second primary input will be summed up (rather than subtracted as was in the adaptive noise canceller technique). The mode selection module may also decide for a selected signal extraction technique, according to the predetermined thresholds from input 9, which signal or signals should be switched in and connected to the receiver and which signal or signals should be switched out and disconnected from the receiver, this information may then be sent to the signal extraction module through communication line 21. In the case when the adaptive noise canceller technique is selected by the mode selection module, the mode selection module may also determine which signal or signals are the aggressors and which signal or signals are the data bearing signals—this information may then be sent to the signal extraction module through communication line 21.

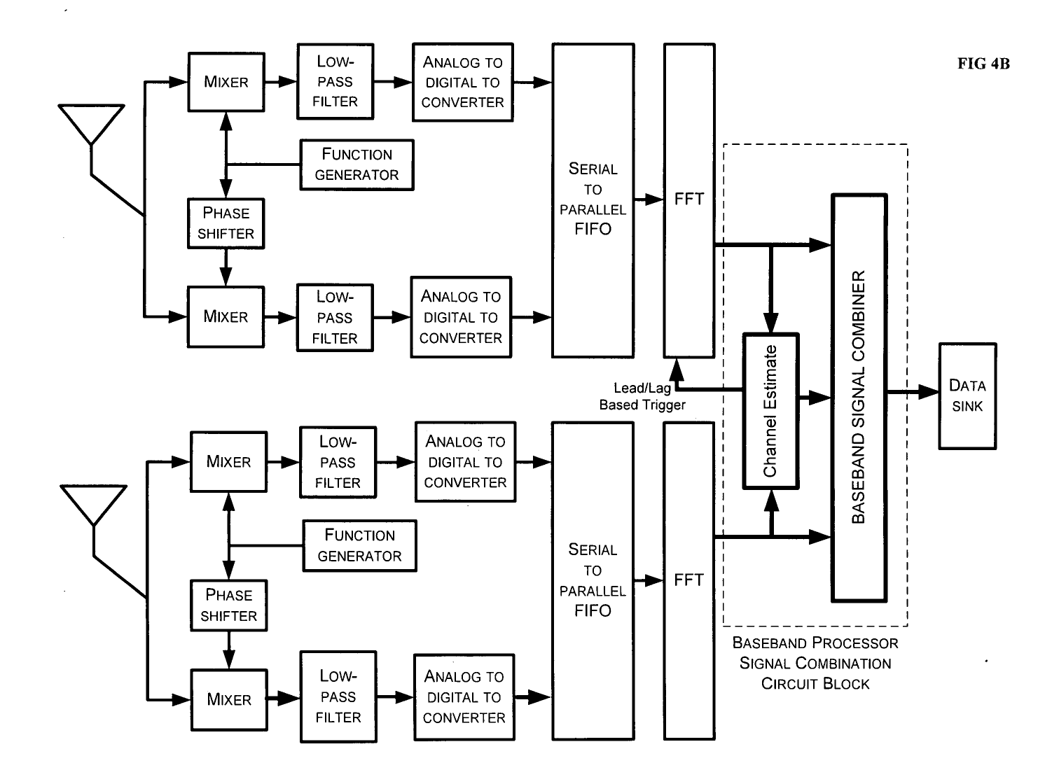

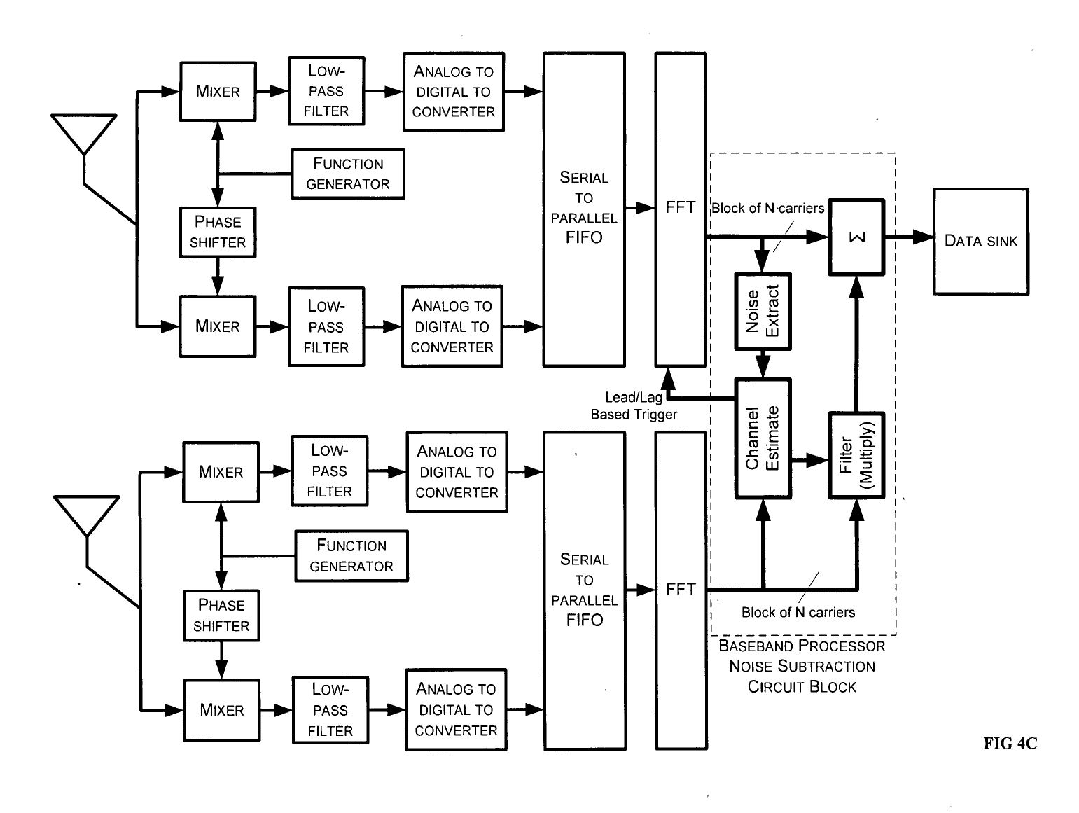

Turning now to FIG. 4A, there is shown a functional block diagram of a signal extractor according to some embodiments of the present invention, wherein the multimode baseband processing processor includes both signal combining and noise subtraction circuits. FIG. 4B is a functional block diagram of the signal extractor segment of FIG. 4A, wherein the extractor is configured to operate in a signal combining mode and there is explicitly shown an exemplary signal combining circuit according to some embodiments of the present invention. FIG. 4C is a functional block diagram of the signal extractor segment of FIG. 4A configured to operate in a noise subtraction/reduction mode and there is an exemplary noise subtraction/reduction circuit shown.

It should be understood that although specific signal combining and noise subtraction circuits were shown, any such circuits, known today or to be devised in the future may be applicable to the present invention.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

What is claimed:

1. A receiver unit comprising:
a first receive chain including a first antenna and a second receive chain including a second antenna, each of which chains is adapted to receive a common communication signal including common communication data;
a multimode data extractor adapted to extract the common communication data from the communication signals received on either or both of said chains; and
mode selection logic adapted to select a mode of operation from a set of selectable modes and to configure said multimode extractor based on the selected mode;
wherein the set of selectable modes includes: (a) a first mode including signal combination of the common signal received on both chains, and (b) a second mode including noise subtraction of noise received on the first chain from a noisy signal received on the second chain.

2. The unit according to claim 1, further comprising received signal parameter measurement circuitry adapted to measure at least one parameter of a signal received by each of the first and second chains, wherein the measured signal parameter is signal strength and/or signal quality.

3. The unit according to claim 2, wherein said mode selection logic is adapted to select a mode of operation based on an output of said measurement circuitry.

4. The unit according to claim 1, wherein the set of selectable modes further includes chain selection mode, such that communication data is extracted from a signal received on only one of said chains.

5. The unit according to claim 4, wherein chain selection mode includes at least a partial shutdown of an unselected chain.

6. The unit according to claim 1, wherein the set of selectable modes includes a switching mode, such that the communication data is extracted from a signal received on only one of the chains.

7. A mobile digital television unit comprising:
a video display adapted to display received video data;
a first receive chain including a first antenna and a second receive chain including a second antenna, each of which chains is adapted to receive a common video signal including common video data;
a multimode video data extractor adapted to extract the common video data from the video signals received on either or both of said chains;
mode selection logic adapted to select a mode of operation from a set of selectable modes and to configure said multimode extractor based on the selected mode; and
wherein the set of selectable modes includes: (a) a first mode including signal combination of the common signal received on both chains, and (b) a second mode including noise subtraction of noise received on the first chain from a noisy signal received on the second chain.

8. The unit according to claim 7, further comprising received signal parameter measurement circuitry adapted to measure at least one parameter of a signal received by each of the first and second chains, wherein the measured signal parameter is signal strength and/or signal quality.

9. The unit according to claim 8, wherein said mode selection logic is adapted to select a mode of operation based on an output of said measurement circuitry.

10. The unit according to claim 7, wherein the set of selectable further modes includes a chain selection mode, such that video data is extracted from a signal received on only one of said chains.

11. The unit according to claim 10, wherein chain selection mode includes at least a partial shutdown of an unselected chain.

12. The unit according to claim 7, wherein the set of selectable modes further includes a switching mode, such that the video data is extracted from a signal received on only one of chains.

13. A method of receiving mobile digital television comprising:
receiving a common video signal over a first receive chain including a first antenna and a second receive chain including a second antenna, wherein each of the chains is adapted to receive the common video signal including common video data;
selecting a mode of operation from a set of selectable modes for a multimode data extractor, wherein the set of selectable modes includes: (a) a first mode including signal combination of the common signal received on both chains, and (b) a second mode including noise subtraction of noise received on the first chain from a noisy signal received on the second chain; and
extracting the common video data from the video signals received on either or both of said chains based on the selected mode.

14. The method according to claim 13, further comprising measuring at least one parameter of a signal received by each of the first and second chains, wherein the measured signal parameter is signal strength and/or signal quality.

15. The method according to claim 14, wherein selecting a mode of operation is based the measurement.

16. The method according to claim 13, further including chain selection such that video data is extracted from a signal received on only one of said chains.

17. The method according to claim 16, wherein chain selection includes at least a partial shutdown of an unselected chain.

18. The method according to claim 13, further includes switching, such that the video data is extracted from a signal received on only one of chains.
